(19) United States
(12) Patent Application Publication
(10) Pub. No.: US 2024/0246010 A1
(43) Pub. Date: Jul. 25, 2024

(54) METHOD AND SYSTEM FOR PURIFICATION OF OIL

(71) Applicant: ROCCO SLOP AB, Östersund (SE)

(72) Inventor: Lasse HURNASTI, Huddinge (SE)

(21) Appl. No.: 18/560,505

(22) PCT Filed: Jun. 2, 2021
(86) PCT No.: PCT/EP2021/064802

§ 371 Date: Nov. 13, 2023

(51) Int. Cl. B01D 17/04; B01D 17/02; B01D 17/12; C10G 31/10

(52) U.S. Cl. CPC B01D 17/047; B01D 17/0205; B01D 17/0217; B01D 17/12; C10G 31/10

(57) ABSTRACT

A method and an oil purification system for purification of contaminated oil, wherein said contaminated oil comprises at least a light phase comprising oil and a heavy phase comprising water, said method comprising the steps of: —adding droplets of heavy phase into the contaminated oil; and —separating the light phase and the heavy phase of the contaminated oil in a separation device.

### TECHNICAL FIELD OF THE INVENTION

The present invention relates to a method and a system for purification of oil.

### BACKGROUND OF THE INVENTION

Purification of oils, such as for example slop oil, waste oil, slurry oil, crude oil, industrial oil, petroleum products or bio-oils is important for the possibility to use/reuse oils and therefore an important factor for the environmental future and the limited nature resources of oils. Purification of slop oil (and waste oil, hereafter only referred to as slop oil) is problematic in many ways. Slop oil can comprise oil, water, particles and emulsion phase. The particles can stabilize the emulsion phase and complicate a purification process. Purification of industrial emulsions comprising water and oil, such as for example cutting fluids is also an important environmental issue.

In slop oil treatment, centrifuge systems are often used for example for separation of oil and water. Slop oils comprise different ingredients, such as different types of oils, water and particles, in different amounts. Hereby a composition of the slop oil will differ between each batch of slop oil to be purified. For example, a density and a viscosity of the oil in the slop oil will differ between different slop oils. Different types of oils may be present in the slop oil in different ratios and the different oils may have different viscosities. Hereby treatment conditions are very different for all batches of slop oil to be purified. This may be the case also for other types of oil to be purified, such as different types of industrial oils. A good purification result will not be achieved when different contaminated oils, such as different batches of slop oils are purified in the same system.

Small water droplets are hard to remove from oil. For example, disc stack centrifugal separators can only remove all water droplets above a certain size. This size is dependent on both the centrifugal separator itself and on viscosity and density differences of the oil. Small water droplets are also hard to get rid of in other types of separation devices.

### SUMMARY

An object of the present invention is to provide an improved method and system for purification of contaminated oils.

A further object of the invention is to provide an oil purification method and system by which small droplets of a heavy phase, for example water, efficiently are removed from the contaminated oil.

This is achieved by a method and a system according to the independent claims.

According to one aspect of the invention a method for purification of contaminated oil is provided, wherein said contaminated oil comprises at least a light phase comprising oil and a heavy phase comprising water, said method comprising the steps of:
adding droplets of heavy phase into the contaminated oil; and
separating the light phase and the heavy phase of the contaminated oil in a separation device.

According to another aspect of the invention an oil purification system is provided for purification of contaminated oil comprising at least a light phase comprising oil and a heavy phase comprising water, said oil purification system comprising:
a separation device configured to separate at least the light phase and the heavy phase of the contaminated oil; and
at least one heavy phase addition part which is positioned in the oil purification system such that contaminated oil will be treated in the at least one heavy phase addition part before it is treated in the separation device, wherein said heavy phase addition part is configured to add droplets of heavy phase into the contaminated oil.

Hereby, by adding droplets of heavy phase into the contaminated oil, these added droplets will by coalescence attract droplets of heavy phase already present in the contaminated oil. Hereby droplets of heavy phase will combine into bigger droplets. Especially very small sized droplets of heavy phase can be caught by the added droplets whereby they will be more easily separated in the separation device. A separation device can be effective for removing all droplets above a certain size but will be less effective for removing droplets below a certain size. Hereby this invention will improve separation efficiency by promoting more aggregation/coalescence of the smallest droplets into larger droplets which are easier to separate. The sizes of the added droplets of heavy phase can be controlled to be of suitable size, i.e. suitable for being possible to remove in the separation device and suitable for attracting other droplets of heavy phase. The method and system according to the invention may also be effective for desalting purposes of oils. By adding fresh water as droplets to an oil comprising emulsified water with a high salt content the salt content will be diluted. The added droplets of fresh water will attract emulsified salty water and hereby more of the salty water can be separated in the separation device whereby the oil is desalted.

In one embodiment of the invention the oil purification system further comprises a contaminated oil tank in which contaminated oil to be purified can be provided, and said heavy phase addition part comprises an inlet which is fluidly connected with an outlet of the contaminated oil tank, possibly via one or more other units of the oil purification system and the separation device comprises an inlet which is fluidly connected to an outlet of the heavy phase addition part, possibly via one or more other units of the oil purification system.

In one embodiment of the invention said step of adding droplets comprises controlling a size distribution of said droplets being added. In one embodiment the oil purification system may further comprise a control system, which is provided in communication contact with the heavy phase addition part and configured to control the heavy phase addition part to add droplets of heavy phase with a controlled size distribution. By controlling a size distribution of the added droplets it can for example be avoided to add too small droplets which are hard to remove in the separation device and a size of the added droplets can be optimized for effective coalescence.

In one embodiment of the invention the method further comprises a step of measuring one or more properties in a light phase retrieved from a light phase outlet of the separation device, wherein said one or more properties comprise one or more of a density, a viscosity, an amount of heavy phase content and a flow rate of the light phase and wherein said controlling of a size distribution of the droplets of heavy phase added into the contaminated oil is provided in dependence of at least one value of the measured one or more properties. In one embodiment of the invention said oil purification system further comprises a at least one light phase sensor positioned in the oil purification system for measuring one or more properties in a light phase retrieved from a light phase outlet of the separation device, wherein said one or more properties comprises one or more of a density, a viscosity, an amount of heavy phase content and a flow rate of the light phase and wherein said control system is in communication contact with said at least one light phase sensor and wherein said control system is configured to control said heavy phase addition part to add droplets of heavy phase with a controlled size distribution in dependence of at least one value of said one or more measured properties. Hereby a size distribution of the added droplets can be optimized for different conditions. For example a smaller size of the droplets can be separated effectively in a separation device if the oil viscosity is low and/or if a flow rate is low and hereby droplets of heavy phase of smaller sizes can safely be provided by the heavy phase addition part without a risk that they will not be separated to a high degree in the separation device.

In one embodiment of the invention said step of adding droplets of heavy phase into the contaminated oil comprises adding the droplets via a nozzle into the contaminated oil and the size distribution of said droplets is controlled by controlling a supply pressure to the nozzle. In one embodiment of the invention the heavy phase addition part comprises an inlet which can be connected to a heavy phase source and the heavy phase addition part comprises further a heavy phase delivering device which is configured for delivering heavy phase into the contaminated oil which is treated in the heavy phase addition part. In one embodiment of the invention the heavy phase addition part comprises a pump for pumping heavy phase from the inlet to the heavy phase delivering device, wherein said heavy phase delivering device is a nozzle, wherein the nozzle is positioned in the oil purification system such that droplets of heavy phase can be sprayed through the nozzle into the contaminated oil in the oil purification system.

In one embodiment of the invention the method further comprises a step of measuring a supply pressure to the nozzle and the step of adding droplets comprises controlling a pump in dependence of said measured supply pressure to pump heavy phase from a heavy phase source and through the nozzle such that droplets of heavy phase having a controlled size distribution are provided into the contaminated oil via the nozzle. In one embodiment of the invention said heavy phase addition part comprises a pressure measuring device which is configured for measuring a supply pressure to the nozzle and which is provided in communication contact with the control system, wherein said control system further is provided in communication contact with the pump of the heavy phase addition part, whereby the control system is configured to control the pump in dependence of a measured level of the supply pressure measured by the pressure measuring device. Hereby an outlet pressure of the pump can be controlled with precision and hereby the droplet size distribution can be controlled with precision.

In one embodiment of the invention said step of adding droplets of heavy phase into the contaminated oil comprises adding heavy phase to the contaminated oil in the form of steam, whereby droplets of heavy phase will be formed in the contaminated oil when the steam is condensed. In one embodiment of the invention the heavy phase source comprises steam and the heavy phase delivering device is configured for delivering steam into the contaminated oil to be treated in the heavy phase addition part.

In one embodiment of the invention said step of adding droplets of heavy phase into the contaminated oil comprises adding an amount of heavy phase into the contaminated oil and producing droplets of the added heavy phase in a mixing device.

In one embodiment of the invention said method for purification of contaminated oil is performed in an oil purification system and wherein said step of adding droplets is performed in a heavy phase addition part of the oil purification system, whereby the method comprises an initial step of providing contaminated oil into the heavy phase addition part before the step of adding droplets of heavy phase into the contaminated oil is performed in the heavy phase addition part and wherein a further step of forwarding the contaminated oil from the heavy phase addition part to the separation device, possibly via one or more further purification units, is performed before the step of separating the contaminated oil in the separation device.

In one embodiment of the invention the step of adding droplets of heavy phase into the contaminated oil comprises adding heavy phase into the contaminated oil having a temperature between 60-100 degrees Celsius.

### BRIEF DESCRIPTION OF THE DRAWINGS

FIGS. 1a and 1b show schematically oil purification systems according to the invention.

FIGS. 1c and 1d show schematically parts of a heavy phase addition part according to some examples of the invention.

FIG. 2 is a flow chart of a method according to one embodiment of the invention.

FIGS. 3a, 3b and 3c show diagrams of a droplet grade efficiency for a centrifugal separator for three different oil viscosities.

FIG. 4 is a diagram showing grade efficiency for a centrifugal separator depending on droplet sizes for three different flow rates.

### DETAILED DESCRIPTION OF THE EMBODIMENTS

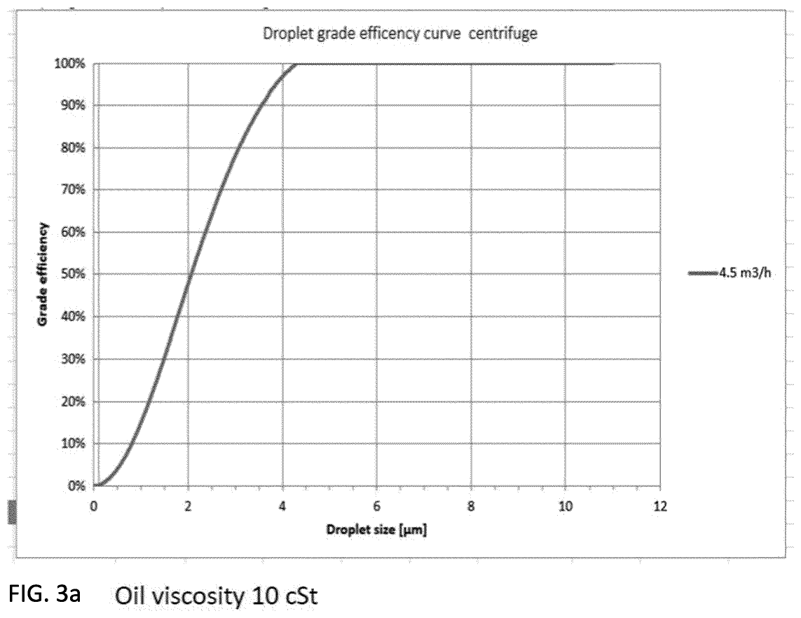

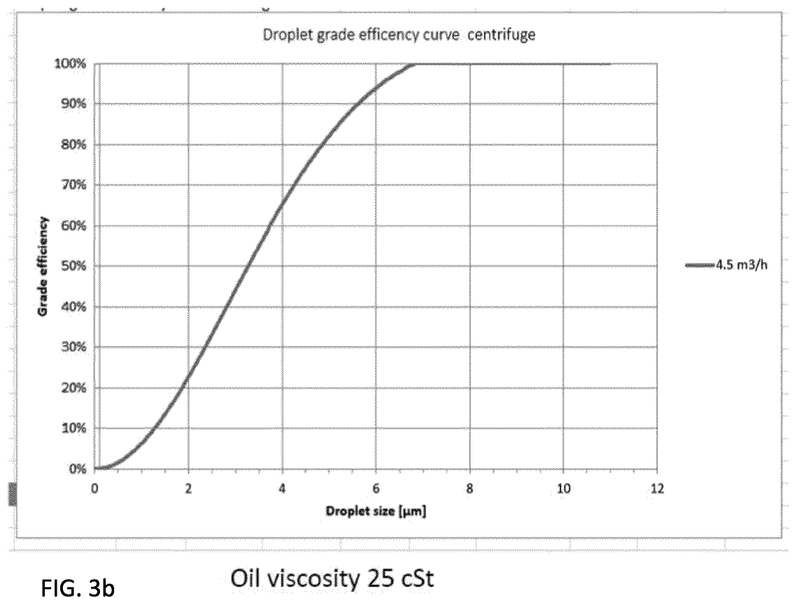

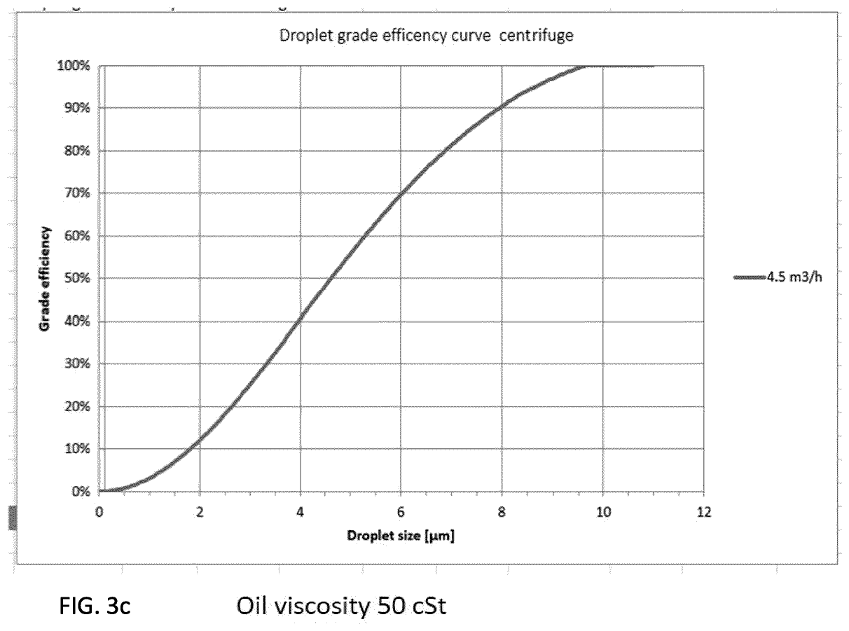

A contaminated oil comprises often a heavy phase (for example water or salty water) and a light phase (different types of oil) as described above. Purification of contaminated oil comprises often a separation of the heavy phase from the light phase. The heavy phase is often, at least to some extent, in the form of small droplets of heavy phase. Droplets can be removed in a separation step but the smaller sizes the droplets have the harder they are to remove. For example, a centrifugal separator will be effective for removing droplets above a certain size to almost 100% but less effective for smaller droplets. The sizes of droplets which can be removed by a centrifugal separator and to what degree they are removed can be illustrated in a grade efficiency curve. Such a curve is dependent on both specific mechanical components and settings in the centrifugal separator but also dependent on for example viscosity and density of the light phase and flow rate. A grade efficiency curve for a centrifugal separator is shown in FIGS. 3a, 3b and 3c for three different oil viscosities in order to exemplify how the oil viscosity is relevant for which droplet sizes that can be removed by one and the same centrifugal separator. Here it can be seen that in oil with a lower viscosity, smaller sized droplets can be more effectively separated. For example, in this centrifugal separator heavy phase droplets with a size above 4 μm are almost separated to 100% in an oil with a viscosity of 10 cSt while only 40% of the heavy phase droplets with a droplet size of 4 μm are separated in the same centrifugal separator if the oil has a viscosity of 50 cSt. These three grade efficient curves as shown in FIGS. 3a, 3b and 3c all use a flow rate of 4.5 m³/h.

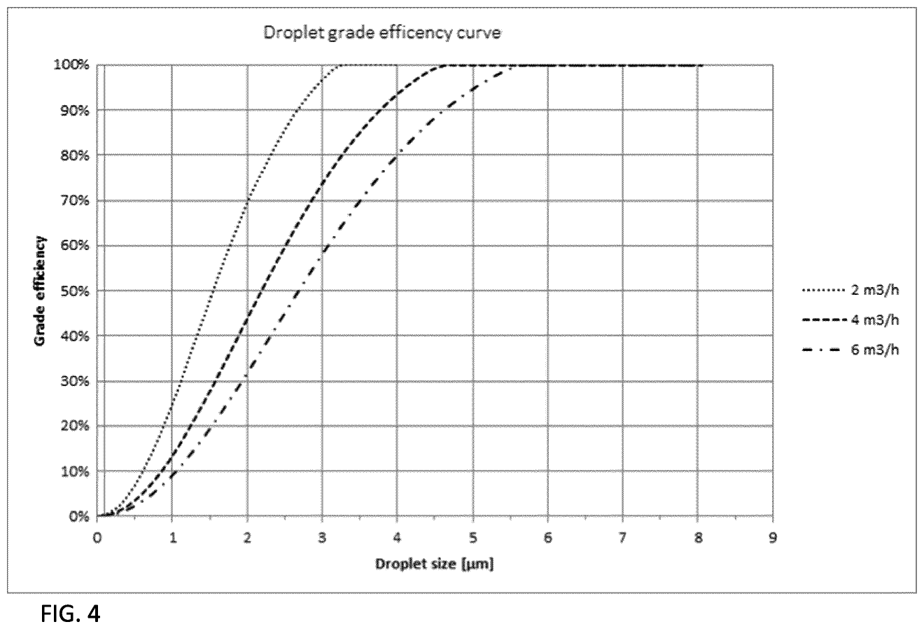

In FIG. 4 a grade efficiency curve for a centrifugal separator is shown for three different flow rates. Hereby it is illustrated how a flow rate is relevant for which droplet sizes that efficiently can be removed by one and the same centrifugal separator. For a flow rate of 2 m³/h for example, almost 100% of heavy phase droplets having a size above 3 μm are separated while for a flow rate of 6 m³/h only about 60% of the heavy phase droplets having a size of 3 μm are separated in the same centrifugal separator.

For achieving a better separation of heavy phase and light phase it would be beneficial to avoid small droplets, i.e. droplets being smaller than a certain limit. However, the size limit of the droplets will be different for different parameters in the system, such as oil viscosity, oil density, flow rate and type of separation device and mechanical settings in this separation device. Referring to the diagrams of FIGS. 3a-3c it would for example, for high oil viscosities be suitable to avoid droplets below 10 μm but for lower oil viscosities droplet sizes as low as 4 μm can be ok. These exact numbers are however only relevant for one specific centrifugal separator and are only given as examples. Furthermore, when purifying slop oil which is comprising different types of oils and emulsions of heavy phase and light phase these parameters will vary for different slop oils to be purified.

By adding droplets of heavy phase to the contaminated oil according to the invention these added droplets will attract (by coalescence) those droplets of heavy phase which are already present in the contaminated oil and the droplets will aggregate and grow in size. Hereby they will be more easily separated in a next separation step, which for example could be a centrifugal separation step. Other separation methods are however also possible such as coalescer filtration or settling. When adding droplets of heavy phase it may be suitable to not add too small droplets which are hard to separate in a next separation step. Hereby, in some embodiments of the invention the added droplets of heavy phase has a size which is larger than a size limit which is set specific for this separation device and which is dependent on for example a light phase viscosity and a flow rate through the system. The size limit is in these embodiments suitably a size of the heavy phase droplets which are separated to 100% or almost 100% in this separation device. Hereby, there is no risk that the added droplets of heavy phase would pass through the oil purification system and not be separated in the separation device. However, if the added small droplets will aggregate to a high degree with other droplets and form larger droplets this may not be a problem. Hereby, in some embodiments of the invention also heavy phase droplets of smaller sizes then such a size limit can be added.

The size distribution of the added droplets of heavy phase is in some embodiments of the invention controlled such that they will attract as much as possible of the heavy phase droplets already present in the contaminated oil and such that they can be separated out in a next separation step. This step of controlling a droplet size distribution can be dependent on a number of parameters. For example, a light phase sensor can be provided in the oil purification system for measuring one or more properties in a light phase retrieved from a light phase outlet from the separation device. The parameters can for example be viscosity, density or flow rate of the light phase or content of heavy phase in the light phase retrieved from the separation device. The controlling of droplet size distribution can hereby be dependent on one or more of these measured parameters whereby the oil purification system can be optimized for efficient oil purification for many different types of contaminated oils and for different conditions. For example, a viscosity and/or a flow rate of the oil can be used as input when a droplet size minimum is set in the system. The system is then optimized for providing heavy phase droplets of a size larger than this droplet size minimum (see FIGS. 3 and 4).

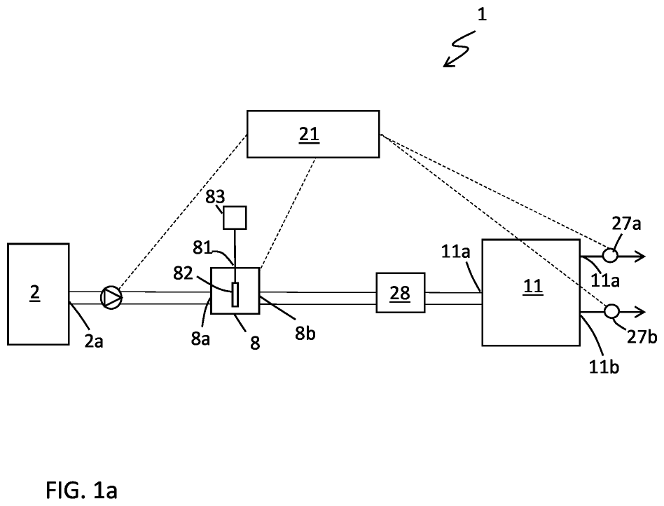

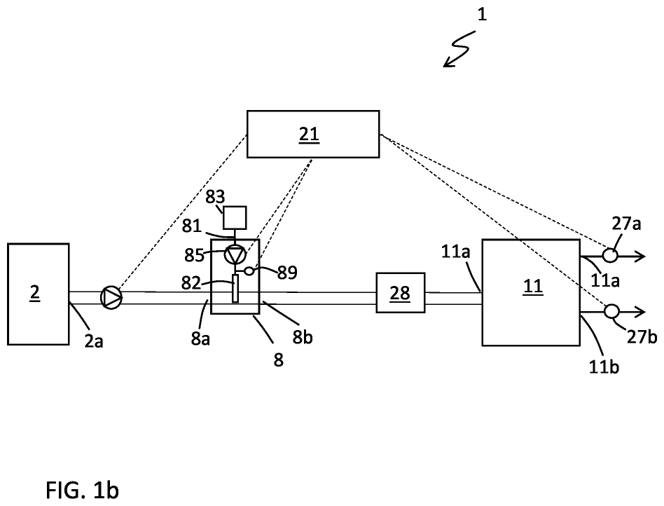

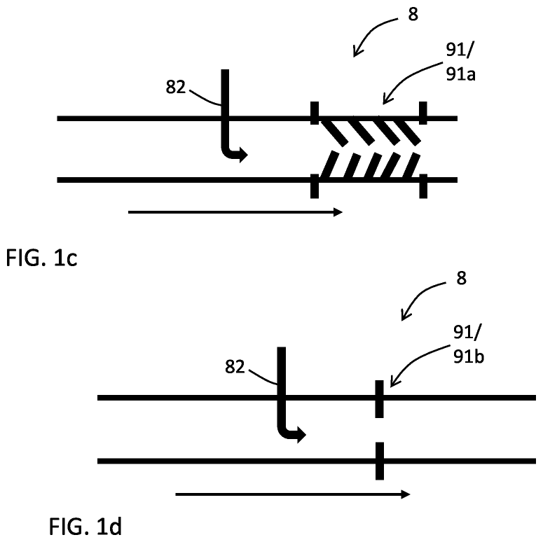

FIGS. 1a and 1b show schematically oil purification systems 1 according to the invention. In FIG. 1a a heavy phase addition part 8 of the oil purification system 1 is illustrated schematically and without specific details, whereby FIG. 1a can be used for a general description of more than one examples of the invention. In FIG. 1b some details of a heavy phase addition part 8 according to one example of the invention is shown and in FIGS. 1c and 1d parts of a heavy phase addition part 8 according to some examples of the invention are shown schematically. Hereby the different examples of details of the heavy phase addition part 8 as shown in FIGS. 1b, 1c and 1d can all be used in the heavy phase addition part 8 as shown in FIG. 1a. Also other examples are encompassed by the general illustration of FIG. 1a as will be discussed below.

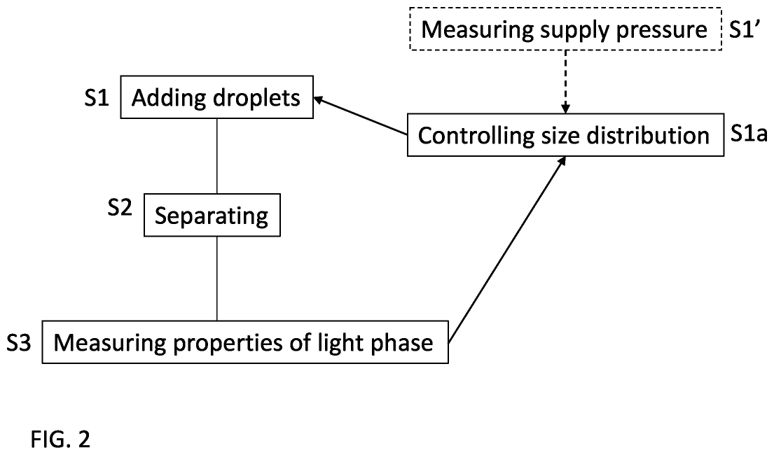

A flow chart of a method for purification of contaminated oil according to some embodiments of the invention is shown in FIG. 2. The contaminated oil comprises at least a light phase comprising oil, which can be oils of different types, and a heavy phase comprising water, which can be for example water, water comprising salt, such as brine or water with added mono ethylene glycol (MEG). The method is described by different method steps listed below:
S1: Adding droplets of heavy phase into the contaminated oil. This can be provided in different ways. One example is to spray heavy phase into the contaminated oil from a heavy phase delivering device 82 in the form of a nozzle. Droplets of heavy phase will be formed directly by the nozzle and droplets of heavy phase are hereby added to the contaminated oil. Another example is to add heavy phase in the form of steam into the contaminated oil from a heavy phase delivering device 82. The steam will condense in the contaminated oil and hereby produce droplets of heavy phase. Still a further example is to add heavy phase to the contaminated oil from a heavy phase delivering device 82 whereby the added heavy phase is transferred into a mixing device 91 where it is mixed into droplets. The mixing device 91 can be for example a static mixer, a mixer with moving parts, a mixing pump or one or more restrictions in a pipe transferring the contaminated oil. The heavy phase can suitably be added at a temperature which is at least about the same as the temperature of the contaminated oil. The temperature can be for example 60-100° C. If the added heavy phase is steam the temperature will be higher.

The step of adding droplets, S1, comprises in some embodiments the step of controlling a size distribution, Sla, of said droplets being added. Hereby droplet sizes of the added droplets of heavy phase can be optimized for being effective for improving a separation efficiency of the light phase and the heavy phase of the contaminated oil in a next coming separation step. As discussed above, small droplets may be hard to remove. Suitably a droplet size of heavy phase should be kept above a minimum droplet size limit. See for example the diagrams of FIGS. 3 and 4 where it is shown that a centrifugal separator is effective to different degree for different droplet sizes and in dependence on different factors such as viscosity and flow rate. The added droplets of heavy phase should have a suitable size distribution which will vary for different conditions in the system and for different conditions of the contaminated oil as discussed above.
S2: Separating the light phase and the heavy phase of the contaminated oil in a separation device 11 of the oil purification system 1.

In some embodiments of the invention, but not necessarily, the method comprises the further step of:
S3: Measuring, by a light phase sensor 27a, one or more properties in a light phase retrieved from a light phase outlet 11a of the separation device 11, wherein said one or more properties comprise one or more of a density, a viscosity, an amount of heavy phase content and a flow rate of the light phase and wherein said step of controlling of a size distribution Sla of the droplets of heavy phase added into the contaminated oil is provided in dependence of at least one value of the measured one or more properties. Hereby one or more of these parameters can be used for setting an appropriate size distribution of droplets for each specific contaminated oil to be purified. This can also be done automatically and continuously during purification or at repeated intervals or between purification of different batches of contaminated oil.

The step of controlling a size distribution, Sla, will be performed in dependence of how the heavy phase is added. A few different examples have been described above and they will be further described below in relation to FIGS. 1a-1d. If for example the heavy phase delivering device 82 is a nozzle which is spraying heavy phase into the contaminated oil, a pump 85 is also provided in the heavy phase addition part 8. This pump 85 can be controlled by a control system 21. The control system 21 will control an outlet pressure from the pump 85 such that a suitable size distribution of the droplets sprayed by the nozzle is achieved. The pump can also be running at a fixed high speed and pressure to the nozzle will be controlled by a regulating valve installed in-between pump and nozzle. Nozzles having different dimensions of the nozzle outlets can also be provided for optimizing a droplet size distribution. In some embodiments of the invention a step of measuring a supply pressure, S1′, to the nozzle is also provided by a pressure measuring device 89 provided in the heavy phase addition part 8. The control of the size distribution, Sla, of the droplets can then also be dependent on the measured supply pressure. Hereby a control of the pump can be optimized for achieving optimal size distribution of the droplets. The pressure measuring device 89 is hereby also suitably provided in communication contact with the control system 21.

Other possible methods of adding the heavy phase will be described in more details below but for example steam can be added from a heavy phase delivering device 82. The steam will condense into droplets in the contaminated oil. The size distribution of the droplets may be controlled by controlling the steam pressure for example by controlling the opening of a valve provided to a heavy phase source 83 which in this example comprises steam and which can be connected to the heavy phase addition part 8. If heavy phase in another example, instead is added to the contaminated oil by a heavy phase delivering device 82 and then forwarded to a mixing device 91, a size distribution of the droplets may be controlled by controlling controllable parts of the mixing device, such as for example moving parts.

The control system 21 is also in some embodiments provided in communication contact with the light phase sensor 27a. Hereby the control system 21 can use at least one value of the measured at least one parameter as input for controlling a size distribution of added droplets. As discussed above, for example an increased viscosity of the light phase will require the droplets of heavy phase to be larger for being able to be separated efficiently, see the diagrams of FIGS. 3a, 3b and 3c, and an increased flow rate will also require droplets of larger sizes for being able to be separated efficiently (see diagram of FIG. 4). One or more of these parameters may be combined for providing an optimal size distribution of droplets. A measure of the amount of heavy phase in light phase form the light phase outlet 11a may also be a good indication of how to change a size distribution of the added droplets of heavy phase. If there is a too high content of heavy phase in the light phase outlet 11a from the separation device 11 the size distribution may need to changed, for example by controlling the pump 85 to pump at a different pressure for changing droplet sizes sprayed out from the nozzle if the heavy phase addition part 8 comprises a pump and a nozzle.

The addition of droplets of heavy phase according to the invention can in some embodiments of the invention be provided at more than one positions in the oil purification system 1. Hereby different size distributions and/or different methods for adding the heavy phase droplets can be used for the different positions and hereby the method can be more efficient.

A more detailed description of the oil purification systems 1 as shown in FIGS. 1a-1d will now be given. The oil purification system 1 is for purification of contaminated oil comprising at least a light phase comprising oil and a heavy phase comprising water. The oil purification system 1 comprises a separation device 11 configured to separate at least the light phase and the heavy phase of the contaminated oil. The separation device 11 can for example be a centrifugal separator, but can also be other types of separation device such as a settling tank or different water removal filter designs. The oil purification system comprises furthermore at least one heavy phase addition part 8 which is positioned in the oil purification system 1 such that contaminated oil will be treated in the at least one heavy phase addition part 8 before it is treated in the separation device 11, wherein said heavy phase addition part 8 is configured to add droplets of heavy phase into the contaminated oil.

The oil purification system 1 comprises furthermore a contaminated oil tank 2 in which contaminated oil to be purified can be provided. The heavy phase addition part 8 comprises an inlet 8a which is fluidly connected with an outlet 2a of the contaminated oil tank 2, possibly via one or more other units of the oil purification system 1. The separation device 11 comprises an inlet 11a which is fluidly connected to an outlet 8b of the heavy phase addition part 8, possibly via one or more other units 28 of the oil purification system. Other units of the oil purification system can for example be pumps, valves, filters, tanks, buffer tanks, settling tanks, other separation devices or the like.

In some embodiments of the invention the oil purification system 1 further comprises a control system 21, which is provided in communication contact with the heavy phase addition part 8 and which is configured to control the heavy phase addition part 8 to add droplets of heavy phase with a controlled size distribution. As discussed above this control can be done in different ways depending on the type of heavy phase addition part 8.

In some embodiments of the invention the oil purification system 1 further comprises at least one light phase sensor 27a positioned in the oil purification system 1 for measuring one or more properties in a light phase retrieved from a light phase outlet 11a of the separation device 11. Said one or more properties comprises one or more of a density, a viscosity, an amount of heavy phase content and a flow rate of the light phase. The control system 21 is suitably in communication contact with said at least one light phase sensor 27a and said control system 21 is configured to control said heavy phase addition part 8 to add droplets of heavy phase with a controlled size distribution in dependence of at least one value of said one or more measured properties.

In some embodiments of the invention, but not necessarily, the oil purification system 1 further comprises one or more heavy phase sensors 27b positioned in the oil purification system 1 for measuring one or more properties in a heavy phase retrieved from a heavy phase outlet 11b of the separation device 11. Said one or more properties can comprise for example density and flow rate and also these measurements can be used by the control system for controlling the size distribution of added droplets. Hereby the control system 21 can also be provided in communication contact with the one or more heavy phase sensors 27b.

There are many different alternatives for producing droplets in the heavy phase addition part 8 which are covered by the invention. Some examples are shown in FIGS. 1b, 1c and 1d. In FIG. 1a a general illustration is provided intended to cover all examples and other similar examples.

The heavy phase addition part 8 comprises suitably an inlet 81 which can be connected to a heavy phase source 83. The heavy phase addition part 8 comprises furthermore a heavy phase delivering device 82 which is configured for delivering the heavy phase retrieved from the heavy phase source 83 into the contaminated oil which is treated in the heavy phase addition part 8. This is common details for all the examples shown in FIGS. 1a-1d even if the heavy phase delivering device 82 may be different in the different examples.

In FIG. 1b one example of a heavy phase addition part 8 is shown where the heavy phase addition part 8 comprises a pump 85 for pumping heavy phase from the inlet 81 to the heavy phase delivering device 82. In this example the heavy phase delivering device 82 is a nozzle 82, wherein the nozzle 82 is positioned in the oil purification system 1 such that droplets of heavy phase can be sprayed through the nozzle 82 into the contaminated oil in the oil purification system 1. By spraying the heavy phase through a nozzle 82 droplets of heavy phase will be formed. Outlets of the nozzle can be provided in different dimensions whereby different size distributions of droplets can be provided by choosing a suitable nozzle. In this example the heavy phase addition part 8 further comprises a pressure measuring device 89 which is configured for measuring a supply pressure to the nozzle 82. Both the pump 85 and the pressure measuring device 89 are provided in communication contact with the control system 21, whereby the control system 21 is configured to control the pump 85 in dependence of a measured level of the supply pressure measured by the pressure measuring device 89. Hereby the size distribution of the added droplets of heavy phase can be controlled with precision. The pressure measuring device 89 may comprise at least one pressure sensor 89 which can be positioned in fluid connection with an inlet of the nozzle 82. Hereby a supply pressure to the nozzle 82 can be measured.

In another example the heavy phase addition part 8 is configured for adding steam to the contaminated oil whereby the steam will condense in the oil and produce droplets. In this example the heavy phase source 83 comprises steam and the heavy phase delivering device 82 is configured for delivering steam into the contaminated oil to be treated in the heavy phase addition part 8. A valve provided either in the heavy phase addition part 8 or in the heavy phase source 83 can be controlled from the control system in order to control a supply pressure of the steam and thereby also a size distribution of droplets which are formed.

In another example, as schematically illustrated in FIGS. 1c and 1d, the heavy phase addition part 8 is configured to add an amount of heavy phase into the contaminated oil and then produce droplets of the added heavy phase in a mixing device 91. Said mixing device 91 can be for example a static mixer 91a, a restriction 91b, a mixing pump or a mixer with a stirring device such as for example an impeller. The mixing device 91 can in some embodiments be controlled to produce droplets with different size distribution. For example, movable parts in the mixing device can be moved, a restriction can be controlled to provide different amounts of restriction and an impeller can be controlled to rotate at different speeds. This may be controlled from the control system 21 and possibly in dependence of at least one value of one or more measured parameters of the light phase as described above.

1. A method for purification of contaminated oil, the contaminated oil including at least a light phase including oil and a heavy phase including water, the method comprising the steps of:
adding droplets of heavy phase into the contaminated oil; and
separating the light phase and the heavy phase of the contaminated oil in a separation device including a centrifugal separator.

2. (canceled)

3. The method according to claim 1, further comprising a step of measuring one or more properties in a light phase retrieved from a light phase outlet of the separation device, wherein the one or more properties including one or more of a density, a viscosity, an amount of heavy phase content and a flow rate of the light phase, wherein the step of adding droplets includes controlling a size distribution of the droplets being added and wherein the controlling of a size distribution of the droplets of heavy phase added into the contaminated oil is provided of depending on at least one value of the one or more measured properties.

4. The method according to claim 1, wherein the step of adding droplets of heavy phase into the contaminated oil includes using a nozzle to add the droplets into the contaminated oil and wherein the size distribution of the droplets is controlled by controlling a supply pressure to the nozzle.

5. The method according to claim 4, further comprising a step of measuring a supply pressure to the nozzle and wherein the step of adding droplets includes controlling a pump depending on the measured supply pressure to pump heavy phase from a heavy phase source and through the nozzle such that droplets of heavy phase having a controlled size distribution are provided into the contaminated oil by the nozzle.

6. The method according to claim 1, wherein the step of adding droplets of heavy phase into the contaminated oil includes adding heavy phase in the form of steam to the contaminated oil, wherein droplets of heavy phase form in the contaminated oil when the steam is condensed.

7. The method according to claim 1, wherein the step of adding droplets of heavy phase into the contaminated oil includes adding an amount of heavy phase into the contaminated oil and producing droplets of the added heavy phase in a mixing device.

8. The method according to claim 1, wherein the method for purification of contaminated oil is performed in an oil purification system and wherein the step of adding droplets is performed in a heavy phase addition part of the oil purification system, wherein the method comprises an initial step of providing contaminated oil into the heavy phase addition part before the step of adding droplets of heavy phase into the contaminated oil is performed in the heavy phase addition part and wherein a further step of forwarding the contaminated oil from the heavy phase addition part to the separation device is performed before the step of separating the contaminated oil in the separation device.

9. The method according to claim 1, wherein the step of adding droplets of heavy phase into the contaminated oil includes adding heavy phase having a temperature between 60-100 degrees Celsius into the contaminated oil.

10. An oil purification system for purification of contaminated oil including at least a light phase including oil and a heavy phase including water, the oil purification system comprising:
a separation device including a centrifugal separator configured to separate at least the light phase and the heavy phase of the contaminated oil; and
at least one heavy phase addition part which is positioned in the oil purification system such that contaminated oil is treated in the at least one heavy phase addition part before it the contaminated oil is treated in the separation device, wherein the heavy phase addition part is configured to add droplets of heavy phase into the contaminated oil.

11. The oil purification system according to claim 10, further comprising a contaminated oil tank containing contaminated oil to be purified, and wherein the heavy phase addition part includes an inlet fluidly connected with an outlet of the contaminated oil tank and wherein the separation device includes an inlet fluidly connected to an outlet of the heavy phase addition part.

12. The oil purification system according to claim 10, further comprising a control system communicatively connected with the heavy phase addition part and configured to control the heavy phase addition part to add droplets of heavy phase with a controlled size distribution.

13. The oil purification system according to claim 12, wherein the oil purification system further comprises a at least one light phase sensor positioned in the oil purification system for measuring one or more properties in a light phase retrieved from a light phase outlet of the separation device, wherein the one or more properties include one or more of a density, a viscosity, an amount of heavy phase content and a flow rate of the light phase and wherein the control system is communicatively connected with the at least one light phase sensor and wherein the control system is configured to control the heavy phase addition part to add droplets of heavy phase with a controlled size distribution depending on at least one value of the one or more measured properties.

14. The oil purification system according to claim 10, wherein the heavy phase addition part includes an inlet connectable to a heavy phase source and a heavy phase delivering device configured for delivering heavy phase into the contaminated oil treated in the heavy phase addition part.

15. The oil purification system according to claim 14, wherein the heavy phase addition part includes a pump for pumping heavy phase from the inlet to the heavy phase delivering device, wherein the heavy phase delivering device is a nozzle, wherein the nozzle is positioned in the oil purification system such that droplets of heavy phase can be sprayed through the nozzle into the contaminated oil in the oil purification system.

16. The oil purification system according to claim 15, wherein the heavy phase addition part includes a pressure measuring device configured for measuring a supply pressure to the nozzle and which is communicatively connected with the control system, wherein the control system is communicatively connected with the pump of the heavy phase addition part, the control system is being configured to control the pump depending on a measured level of the supply pressure measured by the pressure measuring device.

17. (canceled)

18. The method according to claim 8, wherein the heavy phase addition part is connected to the separation device by one or more of a pump, a valve, a filter, a buffer tank, a settling tank or other separation device.

19. The oil purification system according to claim 11, wherein at least one of:
the outlet of the contaminated oil part is connected with the inlet of the heavy phase addition part by one or more of a pump, a valve, a filter, a buffer tank, a settling tank or other separation device; and
the outlet of the heavy phase addition part is fluidly connected with the inlet of the separation device by one or more of a pump, a valve, a filter, a buffer tank, a settling tank or other separation device.
